(19) United States
(12) Patent Application Publication
(10) Pub. No.: US 2009/0186611 A1
(43) Pub. Date: Jul. 23, 2009

(54) AIRCRAFT BROADBAND WIRELESS SYSTEM AND METHODS

(75) Inventors: W. Herschel Stiles, San Jose, CA (US); Theodore J. Wolcott, Los Altos, CA (US); Dana R. Waldman, Mountain View, CA (US); Edward C. Gerhardt, Malabar, FL (US)

Correspondence Address: Zies Widerman & Malek, P.L., 202 N. Harbor City Blvd, Suite #101, Melbourne, FL, 32935, US

(73) Assignee: Voyant International Corporation, Mountain View, CA (US)

(21) Appl. No.: 12/337,042

(22) Filed: Dec. 17, 2008

Related U.S. Application Data
(60) Provisional application No. 61/014,539, filed on Dec. 18, 2007.

(51) Int. Cl. H04W 4/00; H04W 84/02

(52) U.S. Cl. 455/431; 370/338

(57) ABSTRACT

A broadband wireless system includes a plurality of spaced-apart ground stations for transmitting and receiving signals to and from a respective plurality of aircraft. Each of the plurality of ground stations may include a ground station transceiver including a ground station antenna carried by a mechanically steered platform, a ground station router in communication with the ground station transceiver, and a ground station beacon transceiver in communication with the ground station router. An aircraft transceiver may be carried by each of the plurality of aircraft to be positioned in communication with one of the plurality of ground stations. The aircraft transceiver may include an aircraft antenna mounted to the aircraft, an aircraft transceiver carried by the aircraft and in communication with the aircraft antenna, and an aircraft radio transceiver carried by the aircraft and in communication with the aircraft beacon transceiver. The broadband wireless system may also include a network operations center in communication with each of the ground stations via a global communications network. A ground station transceiver may transmit signals to and receives signals from not more than one aircraft at a time and ground station antenna may track the aircraft with which it is in communication.

### RELATED APPLICATIONS

This application claims the benefit of U.S. Provisional Patent Application Ser. No. 61/014,539 titled Techniques for Broadband Communications for Aircraft filed on Dec. 18, 2007, the entire contents of which are incorporated herein by reference.

### FIELD OF THE INVENTION

The present invention relates to communications systems and, more specifically, to communications systems for providing broadband data access aboard aircraft.

### BACKGROUND OF THE INVENTION

Various techniques have been proposed to provide broadband communications to aircraft for the purpose of, for example, Internet or messaging service to passengers and/or crew. These methods are typically expensive in terms of cost-per-megabit/second of service. Further, these methods may provide insufficient bandwidth to be considered “broadband” for a large or mid-sized passenger aircraft. The methods may also lack scalability needed for Continental US (CONUS) or European coverage, for example.

One method proposed is using a bidirectional satellite service to provide connectivity. While bidirectional satellites can provide significant broadband connectivity with minimal ground-based infrastructure for the communication service provider, the cost is particularly high for multi-megabit/second broadband service needed for hundreds of passengers per plane. This is multiplied when dealing with a large number of airborne aircraft, and even further increased where there is a high density of aircraft in the air at any given time.

In yet another implementation example, VHF or UHF radios are used in an up looking “cellular-like” arrangement in combination with satellites for providing bidirectional communications with the aircraft. The satellites provide downlink (ground access point-to-satellite-to-aircraft) communications and the VHF or UHF radios provide uplink (aircraft-to-ground access point) communications. This method provides greater downlink communications capacity compared to the previous example, but has all the disadvantages of the previous example plus added infrastructure and networking complexity and expense.

One limitation of transmitters in general is their antenna beamwidth. The wider the beamwidth, the lower the frequency re-use. This, in turn, results in lower system capacity and less immunity to co-frequency users. In general, lower-frequency transmitters will suffer these limitations more than higher-frequency transmitters. Frequency re-use is the ability to share the same frequency among different transceivers in close proximity without causing significant mutual interference. For example, transceivers with very narrow beam antennas can share the same frequency in much smaller geographic areas than systems having transceivers with wider beamwidths.

Typically transmission systems use fixed beamwidth antennas. When the communications links vary in elevation, however, such as ground-to-aircraft communications, the elevation angle of the link may affect the range of the needed link. Higher elevation angles may have shorter ranges for ground-to-aircraft communications and, therefore, less gain may be needed (or alternatively, wider beams may be allowable). One way to address this problem is a design for coverage with the same fixed beam size at all elevation angles from near horizon to zenith (vertical). This solution, however, leads to a very large number of beams where fewer would be required if the beamwidths were allowed to vary, increasing in beamwidth as the elevation angle increased. Non-tracking, fixed beamwidth antennas could not efficiently cover a sufficient range from low-elevation to high-elevation links. If the beamwidths are not narrow, however, interference with ground-based transceivers is likely. Further, if the beamwidths are too narrow, too many beams would be required, thus making such a system cost prohibitive.

Many transmission systems use single, fixed bandwidth carriers. However, when the bandwidth requirement varies, fixed-bandwidth transceivers have varying efficiency with respect to frequency re-use, terrestrial interference, and system capacity. Variation in bandwidth requirements can result, for example in inefficient use of fixed allocation spectrum, when accessed for ground-to-aircraft communications systems, when larger or smaller aircraft (more or fewer passengers) use the system.

One service objective in ground-to-aircraft communications is to provide continuous communications when the aircraft passes from one supporting ground station to another. The user traffic (typically, TCP/UDP IP packets) must enter the Internet, for example, from a different network access point each time it enters the service area of a different ground station. By using GPS location information of the aircraft, a network control system can detect the need for handoff from one GS to another and automatically alter the aircraft's IP address to match the new GS's IP addressing scheme, transparently to the users of the system.

VHF radios provide communications for relatively low cost and complexity, but the VHF frequencies are extremely crowded; licensed frequencies are largely unavailable; and interference with existing services is a significant issue. Because of the low bandwidth available for VHF service, scalability is a large issue as well. If licensed VHF frequencies are used (which would be desired for a reliable commercial VHF service), costly licenses or sublicenses must be obtained. The issue is not so much unlicensed band usage itself, as the near omni-directional characteristics of most antennas envisioned for use for either fixed or mobile users in these bands, and the associated difficulty of achieving isolation and independent un-degraded operation is the presence of these users. UHF radios have issues similar to VHF radios, but have shorter range. Satellite circuits, when used alone to provide bidirectional broadband service to aircraft suffer from very high recurring cost, both equipment cost and transponder lease costs. Satellite circuits, when used in combination with VHF or UHF radios to provide bidirectional broadband service to aircraft, suffer from very high recurring cost from the satellite circuits and the added complexity and issues of VHF and UHF circuits, described above. Also, in order to meet broadband connectivity requirements for all aircraft, more licensed spectrum (enabling capacity) is needed than is typically available and ability to use the unlicensed spectrum as a result of near omni antennas is challenging.

Satellites can provide significant broadband connectivity with minimal ground-based infrastructure for the communications service provider, but the cost is particularly high for multi-megabit/second broadband service, needed for hundreds of passengers per plane for a large number of airborne aircraft.

VHF or UHF radios, when used in a cellular-like arrangement for providing bidirectional communications with the aircraft, requires significant infrastructure; suffers from interference with terrestrial communications; suffers from scalability problems; and provides very limited bandwidth.

VHF or UHF radios, when used in a cellular-like arrangement in combination with satellites for providing bidirectional communications with the aircraft, wherein satellites provide downlink (service access point-to-aircraft) communications and VHF or UHF radios provide uplink (aircraft-to-service access point) communications, provides greater downlink communications capacity compared to the previous example, but has all the disadvantages of the previous example plus added infrastructure and networking complexity and expense.

Transmitters with wider beamwidths (lower frequency) decrease the capacity multiplier possible with frequency re-use, which in turn results in lower system capacity and less immunity to co-frequency users. Frequency re-use is only possible where sufficient isolation is achieved between two communications channels, and wider beams make it much more difficult to achieve isolation.

### SUMMARY OF THE INVENTION

The present invention is directed to improvements in ground-to-aircraft and aircraft-to-ground broadband communications and more particularly to techniques for using very narrow-beam transmission (above 10 GHz), adaptive antennas such as variable beamwidth non-tracking or fixed beamwidth tracking antennas, adaptive modulation including varying numbers of individual channels or OFDM carriers and coding levels according to link capability and/or user demand, and GPS location information-based tracking and handoff. Cognitive radio technology can also be used by aircraft and GS transceivers to select a portion of the band that is not currently being used within a geographic area. Radios, while not transmitting, can sample the entire band and measure the noise power in each segment. The best segment choices could be shared between the aircraft and GS transceivers using the beacon transceiver. This technique could also be used to allow a greater transmit power to be used. This increased power would not cause interference into other users if there were no other users in the area. This increase in power would allow for the support of longer ranges, higher link margins (during rain fades) or higher data rates. The transmit power would be decreased back to some lower level whenever another user on the same frequency was detected. Alternatively, a new frequency segment may be identified where no other users are present and the higher transmit power resumed.

In accordance with the present invention, there are a plurality of ground station (GS) transceivers (radios) operating as a part of a network with a plurality of aircraft transceivers (radios). The GS transceivers typically are also at, or at least co-located with, the terrestrial network access points (NAPs) via broadband connections to the NAP's communications service provider. There may be a plurality of GSs to provide coverage over a given area, and a plurality of transceivers at that given GS location. The Network Operations Center (NOC), serves as a control center to provide connectivity management between aircraft and the distributed multiple GSs, including configuration management via a RADIUS server, handoff management, and IP connectivity management via an IP Mobility Server. GS transceivers and aircraft transceivers are of a similar design in the preferred embodiment. In the tracking antenna implementation, the GS transceivers are arranged on individually steerable platforms and each transmit a narrow beam towards its currently assigned aircraft, if any. The GS platform also has share Beacon Transceiver for accepting service requests from an aircraft. The Beacon Transceiver may transmit/receive at the same or at a lower frequency using a much wider beamwidth and is used during the initial acquisition and handoff process for location purposes or it may use the same beamwidth and frequency at a much lower data rate. Subsequently, aircraft GPS location information is passed between the GS transceivers to support handoffs. Similarly, aircraft transceivers operated on a steerable platform and transmit a narrow beam towards its currently assigned GS. Once an aircraft reaches 10,000 feet (or a minimum elevation for service), the Aircraft Beacon Transceiver transmits service Requests every second once enabled. The aircraft transceiver will know the location of all GSs and select the nearest based on GPS information and pre-point its antenna in the direction of the desired GS. This Service Request identifies the aircraft, validates its network license and reports its GPS location. An idle GS terminal within range of the aircraft will respond to the Service Request by transmitting a Service Accept message to the aircraft. This message will contain the GPS location of the accepting GS terminal. Once the GS and the aircraft have each other's exact location, the transceiver antennas are fine-pointed towards each other and a broadband wireless connection is established. Once this initial connection is made, the GS handoff process is used to establish the link to the next GS. When an aircraft approaches the edge of coverage of the present GS, the NOC is notified of the need for a handoff. The NOC assigns a new GS to the aircraft based on the specific aircraft flight path by notifying the new GS, the old GS and the aircraft. The new GS then slews its antenna and points towards the aircraft and begins service. The NOC also assigns a new IP address for the aircraft while in the new GS's area of coverage. When an aircraft is connected to a GS, the aircraft communications traffic is sent to a NAP via a VPN over a back haul circuit to the GS's assigned IP Mobility Server, where the traffic is converted to routable IP packets and sent back to the Internet to the intended destination. In the event of a loss of connectivity between the aircraft and the GS, the aircraft will continue to point towards the selected GS, while the NOC directs the tracking of the GS antenna to a predicted path of the airplane. If reacquisition does not reoccur within the allocated time, the aircraft will reset to the beacon mode of operation and reinitiate initial acquisition.

In another embodiment of the present invention, the GS is comprised of multiple transceivers and corresponding multiple fixed beam antennas. Rather than steering multiple individual antennas, a fixed array of antennas and transceivers are used to provide horizon to horizon coverage for multiple aircraft. The aircraft will have a single transceiver with a tracking antenna, as in the prior embodiment. This type of GS provides coverage for a full hemispherical coverage area without the need of steerable platforms on the GSs. Networks built from this type of GS will require fewer, but more expensive GS antenna subsystems. Otherwise, the network architecture and operations similar to networks comprising steerable antennas, described above.

With the above in mind, it is an object of the present invention to provide a broadband wireless system that enhances data transmission speeds. It is also an object of the present invention to provide a broadband wireless system that provides broadband access onboard an aircraft. It is further an object of the present invention to provide a broadband wireless system that readily maintains broadband connections without service interruptions.

These and other objects, features and advantages of the present invention are provided by a broadband wireless system that may include a plurality of spaced-apart ground stations for transmitting and receiving signals to and from aircraft. Each of the plurality of ground stations may include a ground station transceiver including a ground station antenna carried by a mechanically steered platform. Each ground station may also include a ground station router in communication with the ground station transceiver, and a ground station beacon transceiver in communication with the ground station router.

The broadband wireless system may also include an aircraft transceiver carried by the aircraft to be positioned in communication with one of the plurality of ground stations. The aircraft transceiver may include an aircraft antenna mounted to the aircraft, an aircraft transceiver carried by the aircraft and in communication with the aircraft antenna, and an aircraft radio transceiver carried by the aircraft and in communication with the aircraft beacon transceiver.

The broadband wireless system may further include a network operations center in communication with each of the plurality of ground stations via a global communications network. It is preferably that the ground station transceiver transmits signals to and receives signals from not more than one aircraft at a time. Further, the ground station antenna may track the aircraft with which it is in communication.

The ground station transceiver may include a ground station radio frequency transceiver and a ground station modem. The ground station modem may transmit at a rate up to about 70 Mb/s. The ground station transceiver may operate in a burst mode, which may be defined by a transmission being sent from the ground station transceiver and received by the aircraft transceiver followed by a transmission being sent from the aircraft transceiver and being received by the ground station transceiver. The ground station transceiver and the aircraft radio transceiver may also operate in time-division duplex mode or frequency division duplex mode.

Each of the ground stations may also include a processor in communication with the ground station transceiver, and a stepper motor in communication with the processor. The stepper motor may steer the platform to move the ground station antenna responsive to the processor. The processor may be in communication with the aircraft transceiver, and the platform may be steered based on signals received from the aircraft transceiver. The signals received from the aircraft transceiver may include GPS signals indicating a location of the aircraft to be positioned in communication with a respective one of the plurality of ground stations.

The aircraft radio transceiver may be positioned in communication with an aircraft router carried by the aircraft. The aircraft router may provide a connection to an aircraft service point. The aircraft service point may includes an in flight entertainment system, an aircraft cockpit, a wireless access point or a pico/femto cell for connection to a service provider. The aircraft router may include software to buffer the at least one connection to the at least one aircraft service point.

The broadband wireless system may also include an aircraft terminal processor in communication with the aircraft antenna to track the aircraft antenna towards the ground station transceiver with which it is in communication. Signals transmitted between the aircraft transceiver and the plurality of ground station transceivers may be transmitted using a high frequency so that a transmission beam associated with the signals being transmitted is narrow. The aircraft beacon transceiver may operate at or below 1 GHz. More specifically, the aircraft beacon transceiver may operate in a band substantially similar to a communications link between the aircraft and the ground station transceiver.

When the aircraft is in motion, it becomes necessary to transmit signals to different ground stations in order to maintain service. This process is known as a “hand off”. During the hand off process, the aircraft beacon transceiver may transmit a service request message. An available ground station transceiver may accept the service request message and transmits a service accept message. The available ground station transceivers may be defined by a ground station transceiver that is not in communication with another aircraft. The aircraft transceiver may disconnect from communication with one of the plurality of ground station transceivers upon receipt of the service accept message from the available ground station transceiver.

Signal transmission data rate and modulation format may modified when the aircraft transceiver disconnects from communication with the ground station transceiver and receives the service accept message from the available ground station transceiver to maximize receipt of the service accept message. The aircraft beacon transceiver may transmit the service request message once every second. Further, the aircraft beacon transceiver may transmit the service request message upon reaching a predetermined altitude. The service request message may identify the aircraft and provide the GPS location of the aircraft.

The broadband wireless system according may also include a ground station database in communication with the aircraft transceiver. The ground station database may include ground station locations and points to the nearest ground station. Each of the plurality of ground station transceivers may have a predetermined coverage range. The aircraft may sends a service request message to a closest available ground station transceiver and may receive a service accept message prior to disconnecting from the ground station transceiver with which it is in communication.

A method aspect of the invention is directed to providing broadband wireless access to a moving aircraft. The method may include positioning a plurality of ground station transceivers in communication with a respective plurality of aircraft to transmit and receive signals to and from the respective plurality of aircraft. The method may also include transmitting and receiving signals from the ground station transceivers to one aircraft so that one ground station transceiver is in communication with not more than one aircraft at a time. The method may further include tracking the ground station antenna to the aircraft when the ground station transceiver with which the ground station antenna is associated is in communication with the aircraft.

### BRIEF DESCRIPTION OF THE DRAWINGS

FIG. 1 is a schematic view of a broadband wireless system according to the present invention.

FIG. 2 is a schematic view of an aircraft transceiver and associated cabin equipment of the broadband wireless system illustrated in FIG. 1.

FIG. 3 is a schematic view of a ground portion of the broadband wireless system illustrated in FIG. 1.

FIG. 4 illustrates a network addressing scheme of the broadband wireless system illustrated in FIG. 1.

FIG. 5 is a timing diagram showing an aircraft hand off from one ground station of the broadband wireless system illustrated in FIG. 1 to another ground station of broadband wireless system illustrated in FIG. 1.

FIG. 6 is a schematic view of another embodiment of the aircraft broadband wireless system according to the present invention.

FIG. 7 is an environmental view of a ground station antenna of the broadband wireless system illustrated in FIG. 1.

FIG. 8 is a schematic view of the aircraft transceiver and associated cabin equipment of the broadband wireless system illustrated in FIG. 1.

FIG. 9 is a schematic view of a plurality of aircraft in communication with a plurality of ground stations and showing a handoff from a first ground station to a second ground station according to the present invention.

FIG. 10 is a schematic view of a plurality of aircraft in communication with a respective plurality of ground stations and showing the ground stations being in communication with not more than one aircraft at a time.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and multiple prime notations, when used, refer to similar elements in alternate embodiments.

FIG. 1 illustrates the network architecture in accordance with one aspect of the invention. As shown in FIG. 1, there is a ground station (GS), generally indicated by 10. GS 10 is comprised of four (typical, certain GSs may have greater and some fewer) transceivers 11, in this non-limiting example, a beacon transceiver 12 and a router 18. Connected to GS 10 is an aircraft 14 which includes an airborne transceiver 16 which is in communication with one of the GS transceivers 11. Router 18 uses a terrestrial backhaul link 17 to communicate user traffic between GS 10 and a Communications Service Provider's Network Access Point (NAP) 19 which links GS 10 to the Internet 20. Backhaul link 21 links the Internet 20 the Network Operations Center 22 using either a wireless or wired connection.

Each GS transceiver 11 includes an antenna 15 mounted on a mechanically-steered platform 23. Electronics of the transceiver 11 are preferably mounted on the platform 23. Two stepper motors may position the antenna 15 under direction of the processor in the transceiver 11. Steering may, for example, be based on GPS location information which is preferably provided with traffic bursts received from the aircraft 14 transceiver 16 or the aircraft beacon transceiver 12. The antenna 15 pointing accuracy is preferably maintained to within about 1 degree. A rotary joint may provide transfer of the signal 23, command and monitor signals, and power connections to the stationary mount below platform 23 where a modem, power supply and surge protector are preferably mounted. This entire transceiver 11 assembly may advantageously be mounted under a radome 13 to protect it from the outdoor environment. Ethernet cables 24 (or fiber-optic cables) transfer received user data to router 18 which routes the data packets via cable 17 to a network access point (NAP) 19, which is an access point for the ground station 10 to the Internet 20. Management and user data from the router 18 may be routed to a network operations center (NOC) 22 over a cable 17.

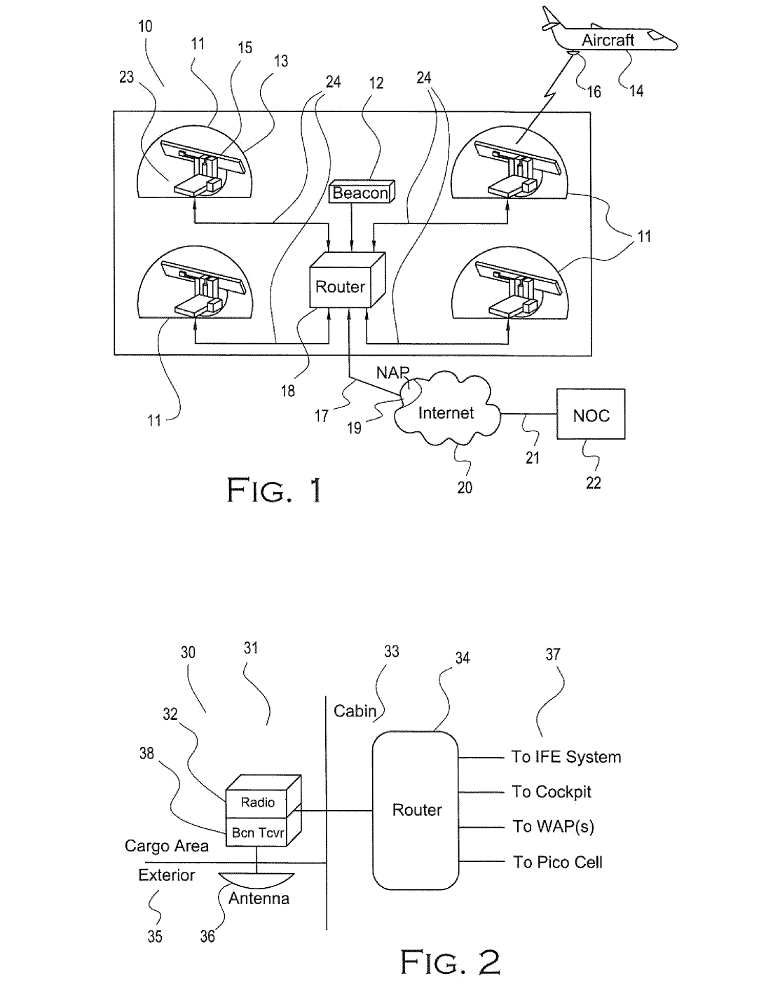

Referring now to FIG. 2, a diagram, generally indicated by 30, illustrates an airborne transceiver. The transceiver 30 includes a radio transceiver 32 and beacon transceiver 38 within or beneath the cargo area 31. Radio transceiver 32 is connected to antenna 36 which is typically mounted on the underside exterior 35 of the aircraft. The aircraft antenna will include a radome and all of the components described for the GS antenna in aircraft suitable format (items numbered 11, 13, 15, and other un-designated components as identified pertaining to FIG. 1). It is also an option to place the radio transceiver 32 and the beacon transceiver 38 on the antenna platform, not show, Radio transceiver 32 is also connected to router 34 within the aircraft cabin 33. Router 34 provides connections to various data service ports 37. In the non-limiting example given, service ports 37 include connections to the cockpit, WiFi wireless access points (WAPs) for passenger service, to Pico/Femto-Cell access devices for passenger cellular messaging and data service, and to the optional aircraft's in-flight entertainment (IFE) system. Radio transceiver 32 may operate in burst, time-division duplex (TDD) mode in the preferred embodiment, although frequency division duplex (FDD) is also an option transparent to the methodology defined herein.

A burst consists of a transmission from the aircraft immediately after receipt of a transmission from the ground station. This ping-pong approach continues throughout the duration of the connection. The terminal processor (not shown) of transceiver 30 controls the pointing of antenna 36 mounted on the exterior surface 35 of the aircraft and ensures that antenna 36 is pointed towards the ground station while the burst is sent.

Radio transceiver 32 is a significant element of the aircraft design. It consists of two significant elements; the RF Transceiver and the Modem (neither shown). The RF Transceiver includes mm-wave circuitry for transmitting and receiving in the mm-wave band (>10 GHz), in the preferred embodiment. It includes a power amplifier, low noise amplifier, transmit/receive switch or transmit/receive diplexer, depending on whether operation is in the TDD mode or FDD option, and synthesized LO for frequency conversion to UHF. A distinguishing feature is that the very high frequency produces very narrow beams, which increases frequency reuse and consequently increases system capacity. The narrow beams also increase immunity to other co-frequency users. Use of the narrow beam is partly enabled by the use of steerable antenna 36 described above.

The Modem includes waveform and digital processing for Orthogonal Frequency Division Multiplexed (OFDM) subcarriers. Up to 2,048 individual carriers are transmitted by the Modem in each burst, depending on the data rate required. This transmission scheme is especially suited for links experiencing multipath fading and Doppler frequency shifts and is a distinguishing feature of the present invention. The transmission rate of the Modem can be configured from 5 to 70 Mb/s in the preferred embodiment and the transmission rate used is typically 50 Mb/s.

This rate can be adapted/changed to match user demands, to increase fade and/or rain margin or to meet field strength limits imposed by regulatory bodies. In addition, variable amounts of forward error correction coding can be used to meet changing link and regulatory conditions. Cognitive radio technology can also be used by the Modem to select a portion of the band that is not being used. Radios, while not transmitting, can sample the entire band and measure the noise power in each sub-carrier or sub-channel. The best sub-carrier and sub-channel choices can be shared between the aircraft and GS transceivers using the Modem itself or via the beacon transceiver. A processor is also included on the Modem card and contains the MAC, antenna positioning and network management software. A standard Ethernet connection is provided for connection to the GS Router 38.

Aircraft Beacon Transceiver 38 preferably operates in the same band as the communications link or in a lower band (typically below 1 GHz). In the preferred embodiment, it will be in the same band as the communications link and is used only for initial GS-aircraft associations, or when the signal is lost due to rain or other uncontrolled outage. As will be shown later, beacon transceiver 38 advertises its need for association with a ground station by transmitting Service Request messages. An available ground station beacon may accept the request with a Service Accept message. Aircraft Beacon Transceiver transmits Service Requests every second, once enabled (typically upon reaching a certain altitude, such as 10,000 feet). This Service Request identifies the aircraft and reports its GPS location. The beacon transceiver in the in-band embodiment may also be provided by the radio transceiver 32, without the need for the separate hardware.

In the in-band embodiment, the aircraft beacon transceiver sends aircraft ID, longitude, latitude, and altitude information as part of the service request message. The aircraft transceiver 30 may contain a database of GS locations and open loop point to the nearest GS, and illuminate the GS beacon transceiver. Under NOC control, this GS will accept the service of the requesting aircraft transponder, or direct it to an alternate GS location. In the preferred embodiment, the beacon transceiver will predominantly be used for pointing the GS antenna, the aircraft antenna will be open loop pointed, however the beacon transceiver will provide backup in adverse scenarios.

Referring now to FIG. 3, a diagram, generally indicated by 40, illustrates a set of ground station (GS) 42 and a Network Operations Center (NOC) 44 connected by the Internet 43. GS 42 includes transceivers 41, router 47 and beacon transceiver 49. One distinguishing feature of the present invention is that it is quite similar to the airborne transceiver of FIG. 2. However, the GS transceiver 41 of FIG. 3 contains multiple transceivers 41. The number of transceivers 41 may be dependent upon the number of aircraft that are to be supported simultaneously in the vicinity of GS 42. Similar to the transceivers illustrated in FIG. 2, the radio transceiver 42 illustrated in FIG. 3 operates in burst, time-division duplex (TDD) mode in the preferred embodiment.

A burst may include a transmission by the GS 42 transceiver 41 followed immediately by a transmission from the aircraft transceiver (not shown). This ping-pong approach continues throughout the duration of the connection. The transceiver processor (not shown) of transceiver 41 may control the pointing of the antenna transceivers 41 (not shown) and ensure that it the antenna transceivers are pointed towards the aircraft while the burst is sent. The GPS location information of the aircraft and GS may be used to compute the elevation and azimuth angles for the antenna. Refer to the description of FIG. 2 for details about the antenna steerable platform, transceiver and beacon transceiver. The GS transceiver 41 of FIG. 3 is packaged for ground deployment rather than within an aircraft, but the essential elements are similar. The antenna size of the GS transceiver 41 may be different from that used on the aircraft.

The GS transceiver 41 is a significant element of the aircraft design. It may include an RF transceiver and a modem (neither shown). The RF transceiver may include mm-wave or mm-band circuitry for transmitting and receiving in a mm-wave bank, i.e., greater than 10 GHz, in the preferred embodiment. It includes a power amplifier, low noise amplifier, transmit/receive switch or transmit/receive diplexer, depending on whether operation is in the TDD mode or FDD option, and synthesized LO for frequency conversion to UHF. A distinguishing feature of the present invention is that the very high frequency produces very narrow beams, which increases frequency reuse and consequently increases system capacity. The narrow beams also increase immunity to other co-frequency users.

The modem includes waveform and digital processing for Orthogonal Frequency Division Multiplexed (OFDM) sub-carriers. Up to 2,048 individual carriers are transmitted by the Modem in each burst. Those skilled in the art will appreciate that the number of individual carriers transmitted by the modem may be dependent upon the data rate required. This transmission scheme is especially suited for links experiencing multi-path fading and Doppler frequency shifts and is a distinguishing feature of the present invention. The transmission rate of the modem can be configured from 5 to 70 Mb/s in the preferred embodiment and the transmission rate used may typically be about 50 Mb/s. This rate can be adapted or changed to match user demands, to increase fade and/or rain margin or to meet field strength limits imposed by regulatory bodies.

In addition, variable amounts of forward error correction coding can be used to meet changing link and regulatory conditions. Cognitive radio technology can also be used by the modem to select a portion of the band that is not being used. Radios, while not transmitting, may sample the entire band and measure the noise power in each sub-carrier or sub-channel. The best sub-carrier and sub-channel choices can be shared between the aircraft and GS transceivers using the modem itself or via the beacon transceiver. If there are multiple aircraft in a given beam, the modem can adapt for different rates/coding on a burst by burst basis. A processor is also included on the modem card and may contain the mandatory access control (MAC), antenna positioning and network management software. A standard Ethernet connection may be provided for connection to the GS router 38.

The GS Beacon Transceiver 49 may operate in-band or in a lower frequency band (typically below 1 GHz). In the preferred embodiment, the GS beacon transceiver 49 preferably operates in-band and is preferably used normally for initial GS-aircraft associations. As will be shown later, an aircraft beacon transceiver advertises its need for association with a ground station by transmitting Service Request messages, and open loop points based on its knowledge of all GS locations and its nearest GS 42. An available ground station beacon transceiver 49 may accept the request with a Service Accept message. Aircraft Beacon Transceivers transmit Service Requests every second, typically, once enabled (preferably upon reaching a predetermined altitude, such as 10,000 feet). This Service Request identifies the aircraft and reports its GPS location, longitude, latitude, and altitude. As the aircraft moves, both the aircraft transceiver (not shown) and the associated GS transceiver 41 track each other based on their respective GPS information. The aircraft transceiver 30 may contain a database of GS locations and open loop point to the nearest GS, and illuminate the GS beacon transceiver. Under NOC control, this GS 42 will accept the service of the requesting aircraft transponder, or direct it to an alternate GS 42 location. In the preferred embodiment, the beacon transceiver 49 is preferably used for pointing the GS antenna (not shown). The aircraft antenna is preferably open loop pointed to the GS 42. The beacon transceiver 49, however, may provide backup in adverse scenarios.

In the preferred embodiment, the beacon transceiver 49 may not be present but may be functionally incorporated into GS 42. The GS antenna (used for normal communications) may be positioned straight-up, i.e., 90 degree elevation angle, whenever not in use and the GS modem may be configured to measure the energy level in a narrow channel at the in-band beacon frequency. The GS antenna pattern may be modified to create a minimum amount of gain at between about 80 and 90 degrees from the axis of the main beam. This gain is preferably directed near the horizon with the GS antenna positioned at about a 90 degree elevation angle. This allows the GS Modem to detect the beacon presence without the need of dedicated beacon transceiver equipment, thus advantageously reducing GS costs.

Network Operations center (NOC) 44 includes a core router 46 and Mobile IP Servers 45. Mobile IP Servers 45 in NOC 44 handle traffic from/to a preassigned set of GSs and GS transceivers 41. Each GS transceiver 41 will have an IP address which will be used for monitor and control information. Aircraft Radios will have IP addresses that will change based on the GS 42 it is associated with, as will be shown later. IP addressing will identify the GS 42, terminal transceiver 41 and aircraft. Packets from an aircraft are transferred from GS 42 over the Internet 43 via router 47 to the NOC core router 46. Core router 46 passes the packets to the proper Mobile IP server 45. Mobile IP server 45 translates the local address of the aircraft to an Internet address, with which Mobile IP server 45 sends the aircraft's packets to the Internet 43. Those skilled in the art will appreciate that the present invention contemplates the use of any global communications network and the invention is not meant to be limited to communication via the Internet. This process is similar to the Mobile IP Server RFC 3220, which enables the transparent transfer of IP datagrams to mobile nodes on the Internet. In this case, the mobile node is an aircraft transceiver. Core router 46 may also transfer IP datagrams from aircraft in-cabin pico/femto-cellular base stations to a cellular gateway 48 for support of cellular data service. Voice traffic can also be supported, if allowed by regulatory bodies. Voice traffic can also be blocked, if disallowed by regulatory bodies or not desired.

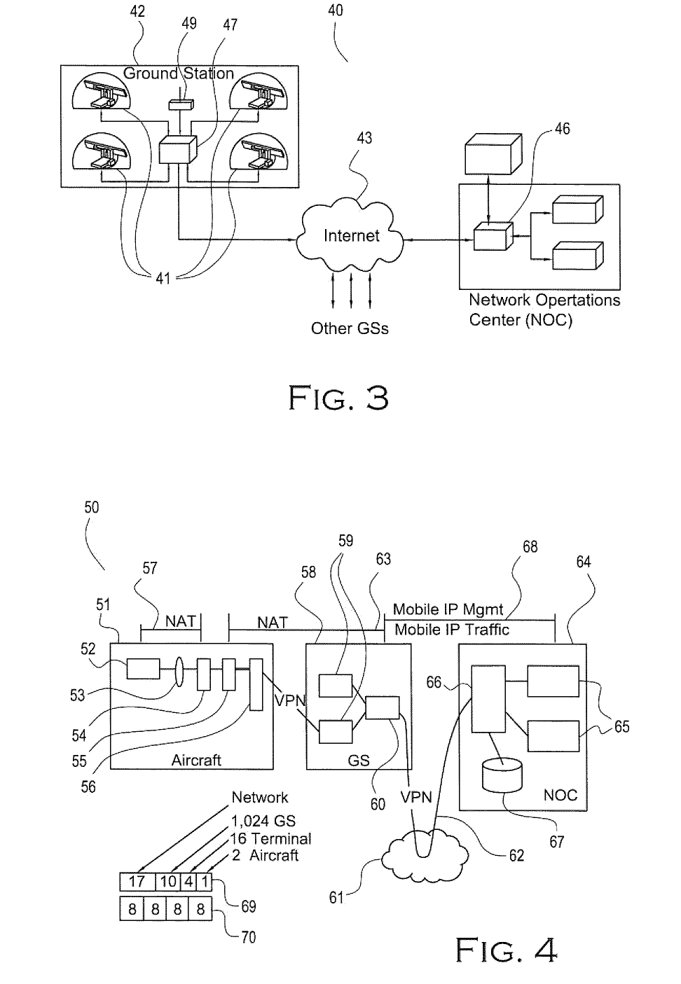

Referring now to FIG. 4, an addressing scheme and the general flow of messages through the system are generally indicated by 50. In the example illustrated in FIG. 4, users 52 may access the broadband ground-to-aircraft network via a WiFi wireless access point (WAP) 54 in the aircraft cabin 51. Wired connections may also operate similarly through a wired router. User 52, may obtain a local network (NAT—network address translation) address from the WAP 54 via the DHCP (dynamic host configuration protocol) protocol. DHCP protocol obtains its local address from an aircraft router 55. Frequently, the WAP 54 and the aircraft router 55 may be a combined device, such as a wireless router, for example, as understood by those skilled in the art. The aircraft router 55 may communicate with the currently associated GS transceiver 59 in GS 58. The GS router 60 may provide the aircraft router 55 with a local address.

In the preferred embodiment, the aircraft router 55 and the GS router 60 communicate via a VPN (virtual private network) set up during the association process. The VPN provides added security through encryption and authentication. NAT, DHCP and VPNs are readily understood by one skilled in the IP networking art to be communications methods suitable to carry out the goals and objectives of the present invention.

The GS router 60 in turn may have a more permanent connection via the VPN 62 to its core router 66 at the NOC 64. The core router 66 may route the packets to the associated IP mobile server 65, where the packet addresses are translated to Internet addresses for routing back through the core router 66 to the Internet 61. Thus, as aircraft 51 may move from one GS 58 to another GS 58, while the user's 52 connection to the Internet remains continuous. This continuity occurs because the network structure is coded into network addressing scheme 69-70. The network addressing scheme 70 may simply indicate that IP addresses include four octets. The coding of the network structure 69 shows that the lowest two bits are assigned to an aircraft within the zone of coverage of a GS 58 transceiver. The terminal (GS transceiver) 59 may be selected by four bits of addressing. Accordingly, there can be 16 radios within a GS 58.

Ten bits determine the GS 60 and, therefore, there may be 1024 GSs 58. Thus there are 15 bits to determine the host (aircraft+GS transceiver+GS), and the remaining 17 bits of the 32-bit IP address 70 designate the network portion of the address. This selection of addressing bits is the preferred embodiment, but many others are adequate as well, as understood by those skilled in the art. The RADIUS (remote authentication dial-in user service) server 67 provides and RFC-based (RFC 2865, 2866) means to provide a policy database for the IP network. It may be used, for example, to store which IP addresses should be served by each router. It may also be used to provide bidirectional authentication credentials for the GS 58/Core 66 and aircraft/GS router 66 connections, as well as for billing/accounting information. It could further implement pricing and throughput class differences desired by different airline customers.

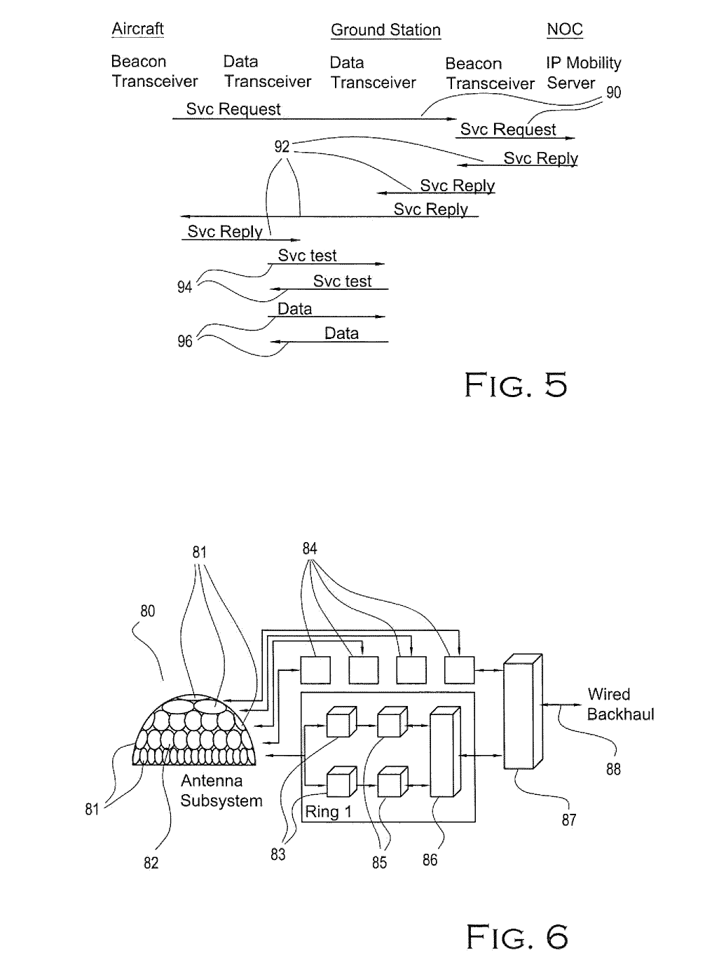

Refer now to FIG. 5, this diagram illustrates a handoff procedure for an aircraft moving from one ground station transceiver to another (at the same or a different ground station). Upon the initial acquisition or subsequent handoff to a ground station transceiver, the aircraft's beacon transceiver sends a service request message 90. This service request message 90 may either be sent via the in-band beacon via an open loop pointed aircraft antenna, based on the aircraft transceiver's knowledge of the location of all GSs and selection of the nearest GS or, if a low frequency beacon is used, to all ground station beacon transceivers within range. In either embodiment, the service request message 90 may contain the aircraft's GPS location information (longitude, latitude and altitude), aircraft identification, and apparent heading (based on earlier GPS location information).

A GS beacon transceiver that receives the service request message 90 may forward it to the NOC's IP mobility server 65 via the backhaul. The IP mobility server 65 may analyze the service request message 90 and database to find the most suitable GS transceiver. Thereafter, the IP mobility server 65 may send a service reply message 92 to the GS beacon transceiver. The GS beacon transceiver may forward the service reply message 92 to the GS data transceiver and to the originating aircraft beacon transceiver. Using the contents of service reply message 92, the GS data transceiver may program its transceiver and steer its antenna in readiness from communication with the aircraft.

When the aircraft beacon transceiver receives the service reply message 92 from the ground station, it similarly forwards the message to the aircraft data transceiver so that the aircraft data transceiver can ready itself for communication with the ground station. The aircraft data transceiver preferably exchanges a test data message 94 with the GS data transceiver. If that exchange is successful, the data transceivers may begin exchanging live user data messages 96 until the edge of coverage is reached and the handoff process begins anew.

Not shown is an optional RADIUS transaction initiated by the IP mobility server upon receipt of a service reply message 92 from the aircraft data transceiver that will program the aircraft's router with the proper IP addresses and credentials. Note that the message exchange protocol of FIG. 5 is representative. As will be understood by one skilled in the art, many variations are apparent. For example, the IP Mobility Server may send service messages 92 to the GS and aircraft beacon transceivers directly. In another example, error-recovery protocols could be used to recover lost messages 90, 92, 94 and 96.

Refer now to the ground station of FIG. 6, a different antenna subsystem may be used and is contemplated by the present invention. Rather than a multitude of steerable beam antennas, an array of fixed beam antennas may used. In the figure, antenna subsystem 80 includes five rings 81 of individual antennas 82. The rings 81 are also shown diagrammatically via ring details 84. The higher rings 81 have progressively fewer antennas 82 of a wider beamwidth. This antenna subsystem 80 preferably includes a collection of antennas 82 of various sizes oriented to collectively illuminate the entire hemisphere (volume) above the horizon. A total of 169 antennas 82 are used to provide overlapping coverage and configured in a set of five (5), horizontal rings 81.

The antennas 82 in the lowest ring (Ring 1) 81, 84 are pointed near the horizon and have higher gain and narrower beams (i.e., 4 degrees) than those pointed at higher elevations (Rings 2-5) 81, 84. Aircraft near the horizon will be up to 85 miles from the GS so this higher gain is required. Over 80% of the aircraft within sight of this GS will be at lower elevation angles and served by Ring 1, 81 antennas 82. The narrower beams will also allow the spectrum to be reused more often, thus increasing the overall network capacity. 96 antennas 82 are preferably included in Ring 1, 81 along the horizon. These antennas 82 collectively provide overlapping, azimuth coverage of 360 degrees. A low loss, ferrite switch matrix 83 allows an online radio (transceiver) 85 or its backup radio 85 (not shown) to support up to 16 antennas 82. Thus, six radios 85 are required to support Ring 1, 81. More radios can be added as required capacity increases. This redundant radio 85 configuration significantly improves GS reliability.

The second ring (Ring 2) 81 consists of 48 antennas 82 each with an 8-degree beamwidth. The same 16:1 switch matrix 83 may be used to share three (3), redundant pair of radios 85 with the 48 antennas 82. More radios can be added as required capacity increases. The third ring 81 consists of 16 antennas 82 each with a 24-degree beamwidth. A single radio 85 plus spare may be shared among the Ring 3, 81 antennas 82. This ring 81 uses an 8:1 switch matrix 83 to switch a single radio 85 to anyone of the eight antennas 82. More radios can be added as required capacity increases.

The final ring (Ring 5) 81 consists of a single antenna 82 and radio 85. It covers a 90-degree area directly above the GS. More radios can be added as required capacity increases. Those skilled in the art will appreciate that rings 4-5, 81 could include spare radios. Collectively these two top rings 81 only cover about 0.3% of the total area above the GS. More radios can be added as required capacity increases. Therefore, they will rarely see an aircraft within their beams.

A total of 12 online and 10 spare radios 85 may be used to communicate with all of the aircraft served by a GS, in the preferred embodiment. Spare radios 85 may automatically be switched online in the event of an online radio 85 failure. In this particular embodiment, the antennas 82 are not steered or moved. More radios can be added as required capacity increases. They are fixed pointed at predetermined azimuth and elevation angles to create the 100% coverage pattern above the GS. Aircraft may move through adjacent GS antenna 82 beams as they fly past a GS. Communications between the GS and aircraft radios provides seamless handoffs as the aircraft flies by. Eventually, a handoff to an adjacent GS occurs which is also performed without interruption to traffic. Each radio operates in burst, time-division duplex (TDD) mode and can select any one of up to 16 antennas 82 for each burst. A burst includes a transmission to the aircraft immediately followed by transmission from the aircraft. The radio may control the switch matrix 83 to select the antenna that is pointed towards the aircraft where the next bust is to be sent.

Acquisition of an aircraft-to-GS connection is similar to the preferred embodiment illustrated in FIG. 3, and uses the same embodiment of a beacon transceiver. Networking of GSs of FIG. 6 is similar to the design of FIG. 3. Note that the actual ring and antenna beamwidth configurations included in FIG. 6 can be altered to improve coverage efficiencies or purposely exclude certain areas which are known to not have any aircraft traffic. Initial acquisition may be done using the Beacon Transceiver (not shown) as described previously. Many variations in the geometry of the antennas 82 and rings 81 will be apparent to one skilled in the art.

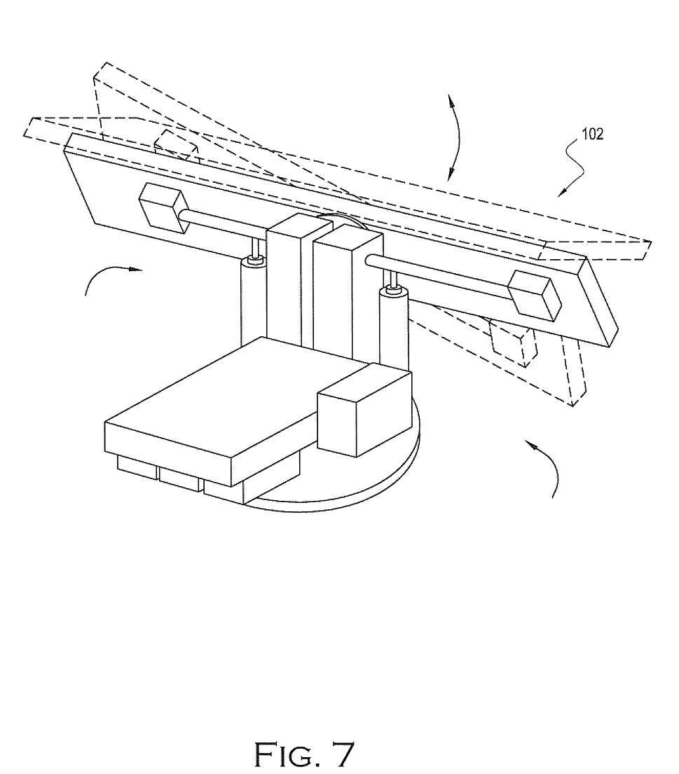

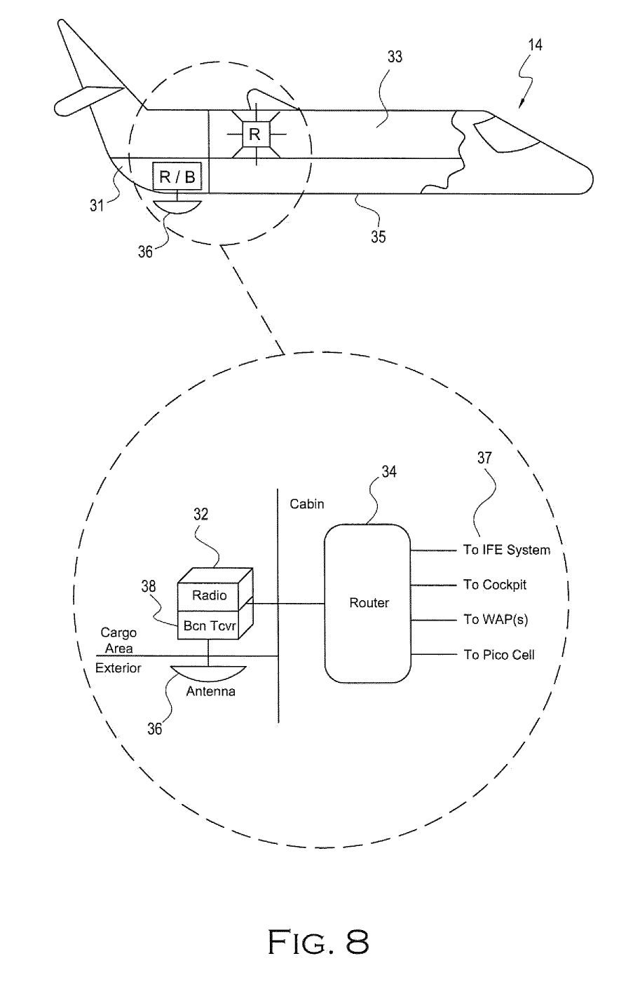

Referring now additionally to FIGS. 7-10, additional aspects of the broadband wireless system 100 according to the present invention are now provided. As discussed in greater detail above, each ground station includes at least one ground station transceiver. FIG. 7 illustrates a typical ground station antenna 102 that may be carried by a mechanically steered platform. As illustrated, the ground station antenna is moveable in the X, Y and Z axes so as to advantageously provide enhanced pointing capabilities. These steering capabilities advantageously allow the ground station antenna 102 to be readily pointed to an aircraft with which it is connected to.

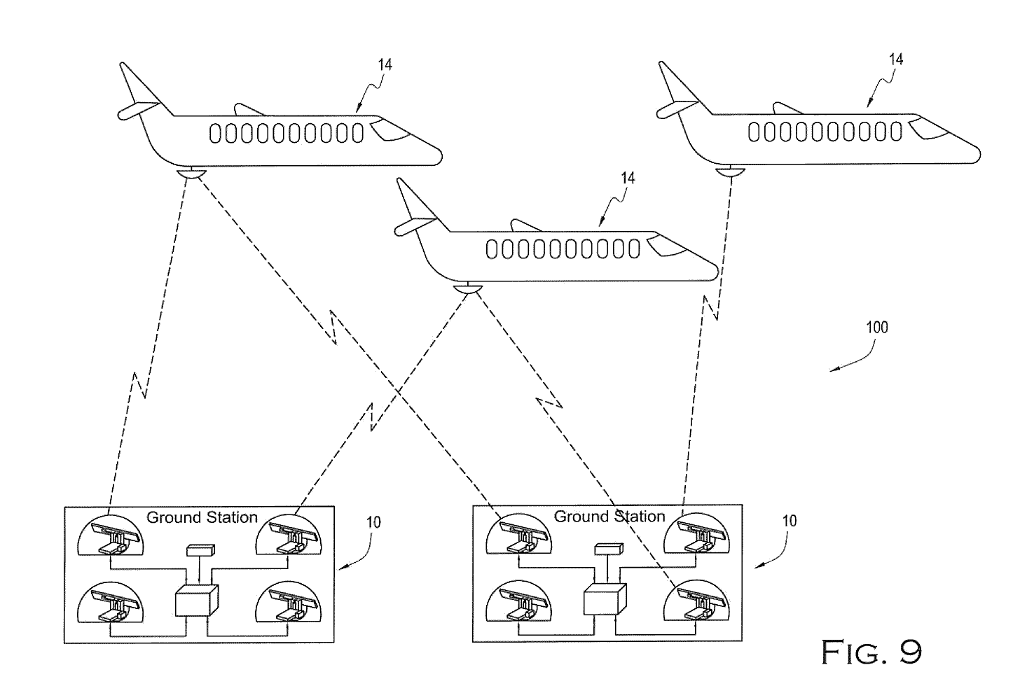

FIG. 8 is a schematic illustration of the location of the aircraft transceiver and associated cabin equipment which is illustrated in FIG. 2 and described in greater detail above. More particularly, the aircraft transceiver is illustratively carried by the aircraft 14. As discussed above, the aircraft transceiver is preferably positioned in communication with one of the plurality of ground stations 10 and includes an aircraft antenna 36 mounted to an exterior portion 35 of the aircraft. Those skilled in the art will appreciate that the invention is preferably carried out wherein signals are transmitted between the ground stations 10 and the aircraft 14 flying overhead and, as such, it is preferable that the aircraft antenna 36 be mounted to an underside of the aircraft.

The aircraft transceiver includes an aircraft beacon transceiver 38 and beacon transceiver 32 both positioned in communication with the antenna. More specifically, the aircraft beacon transceiver 38 and the aircraft radio transceiver 32 are preferably carried within a cargo area 31 of the aircraft 14. The aircraft radio transceiver 32 and the aircraft beacon transceiver are illustratively positioned in communication with the aircraft router 34. The aircraft router 34 is preferably carried by the aircraft 14 and, more specifically, within the cabin of the aircraft. The aircraft router 34 illustratively provides connections to aircraft service points 37. These aircraft service points 37 may, for example, include an in flight entertainment system, the cockpit of the aircraft, wireless access points, pico/femto cells for connection to a service provider, or any other number of service points as understood by those skilled in the art.

As discussed in greater detail above, the aircraft router 34 may include buffering software to buffer connections to the aircraft service points 37. The buffering software advantageously minimizes the risk of losing a connection to an aircraft service point 37. This is particularly advantageous when the aircraft 14 is moving from being in communication with a first one of the plurality of ground stations to being in communication with a second one of the plurality of ground stations. During this handoff process it is possible to lose communication with a ground station for a brief period of time, but buffering the connections to the aircraft service points 37 advantageously decreases the possibility of the end user losing their connection to the aircraft service point.

As also discussed above, each of the plurality of ground stations 10 includes a ground station router 18 in communication with the ground station transceivers 11. The ground station 10 also includes a beacon transceiver 12 in communication with the router 18. As illustrated in the appended figures, the broadband wireless system 100 also includes a network operations center 22 in communication with the ground stations 10 via a global communications network 20, i.e., the Internet. As will be discussed in greater detail below, each of the plurality of ground station transceivers 11 transmit signals to and receive signals from not more than one aircraft at a time. Further, the ground station antenna preferably tracks the aircraft with which it is in communication. Similarly, and as discussed in greater detail above, the ground station antenna may track the ground station transceiver with which it is in communication with.

The broadband wireless system 100 also includes an aircraft terminal processor in communication with the aircraft antenna. The aircraft terminal processor tracks the aircraft antenna towards the ground station transceiver with which it is in communication. This advantageously enhances the quality of the connection between the aircraft and the ground station transceiver, thereby enhancing data transmission to the aircraft. The aircraft beacon transceiver 38 of the broadband wireless system 100 operates in a band similar to the communications link between the aircraft and the ground station transceiver 11.

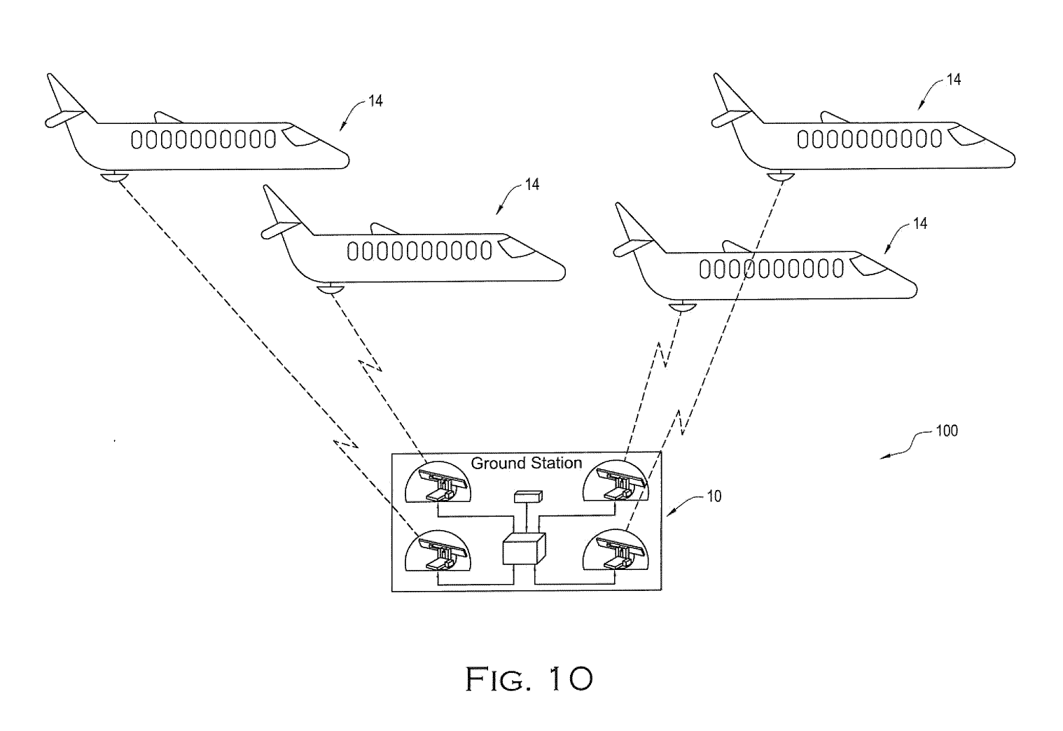

Referring now more specifically to FIGS. 9 and 10, a handoff procedure is now described. The handoff procedure may be defined by the aircraft 14 traveling out of the range of a ground station transceiver with which it is in communication to the range of a ground station transceiver 11 with which it desires to be in communication with. Accordingly, the aircraft beacon transceiver 38 may transit a service request message. An available one of the ground station transceivers 11 may accept the service request message and transmit a service accept message to the aircraft beacon transceiver 38. The available one of the plurality of ground station transceivers 38 may be defined by a ground station transceiver that is not in communication with another aircraft 14. Thereafter, the aircraft beacon transceiver 38 may disconnect from communication with one of the plurality of ground station transceivers 11 upon receipt of the service accept message from the available one of the ground station transceivers.

The aircraft beacon transceiver 38 may transmit the service request message once every second. Those skilled in the art, however, will appreciate that the broadband wireless system 100 according to the present invention may cause the service request message to be transmitted as frequently or infrequently as desired. Further, those skilled in the art will appreciate that the broadband wireless system 100 according to the present invention may cause the service request message to be transmitted upon the occurrence of a predetermined event. For example, the service request message may be transmitted upon the aircraft 14 reaching a predetermined altitude. The service request message may identify the aircraft 14 and provide GPS location information of the aircraft.

In an alternate embodiment of the broadband wireless system, each of the plurality of ground stations includes an antenna subsystem 80. This is illustrated, for example, in FIG. 6. The ground station antenna subsystem 80 illustratively includes a plurality of ground station antennas 81 arranged in a stacked formation. The ground station antenna subsystem also includes a ground station router in communication with the plurality of ground station antennas and a ground station beacon transceiver in communication with the ground station router.

This alternate embodiment of the broadband wireless system also includes an aircraft transceiver carried by each of the plurality of aircraft to be positioned in communication with one of the plurality of ground stations. The aircraft transceiver may include an aircraft antenna mounted to the aircraft, an aircraft beacon transceiver carried by the aircraft and in communication with the aircraft antenna, and an aircraft radio transceiver carried by the aircraft and in communication with the aircraft beacon transceiver. The ground station antenna subsystem 80 transmits signals to and receives signals from not more than one aircraft at a time.

The stacked formation of the plurality of ground station antennas 81 includes a plurality of rings of ground station antennas. The plurality of rings of ground station antennas 80 may include five rings, wherein a lowermost one of the five rings includes a first predetermined plurality of ground station antennas; wherein upper rings positioned above the lowermost one of the five rings includes less ground station antennas than the lowermost ring. The uppermost one of the five rings preferably includes one ground station antenna. Those skilled in the art will appreciate that the ground station antenna subsystem may include any number of rings of antennas 81 and that each of the rings of antennas may include any number of antennas.

The ground station antenna subsystem 80 may include a ground station radio frequency transceiver and a ground station modem. The ground station modem may transmit at a rate up to about 70 Mb/s. The ground station antenna subsystem 80 may operate in a burst mode, which, as discussed above, may be defined by a transmission being sent from the ground station antenna subsystem and received by the aircraft transceiver followed by a transmission being sent from the aircraft transceiver and being received by the ground station antenna subsystem. The ground station antenna subsystem 80 and the aircraft radio transceiver may operate in at least one of time-division duplex mode and frequency division duplex mode.

The aircraft transceiver transmits GPS signals indicating a location of the aircraft to be positioned in communication with a respective one of the plurality of ground station antenna subsystems 80. The aircraft radio transceiver may be positioned in communication with an aircraft router carried by the aircraft. The aircraft router may provide at least one connection to at least one aircraft service point. The at least one aircraft service point may include at least one of an in flight entertainment system, an aircraft cockpit, at least one wireless access point and at least one pico/femto cell for connection to a service provider. The aircraft router may include software to buffer the at least one connection to the at least one aircraft service point.

The broadband wireless system may also include an aircraft terminal processor carried by the aircraft and in communication with the aircraft antenna to track the aircraft antenna towards the respective at least one ground station antenna subsystem 80 with which it is in communication. The signals transmitted between the aircraft transceiver and the respective ground station antenna subsystem 80 with which it is in communication are transmitted using a high frequency so that a transmission beam associated with the signals being transmitted is narrow. The aircraft beacon transceiver may operate at or below 1 GHz. Similarly, the aircraft beacon transceiver may also operate in a band substantially similar to a communications link between the aircraft and the ground station antenna subsystem 80.

With respect to the handoff procedure described above, the aircraft beacon transceiver may transmit a service request message, and an available one of the plurality of ground station antenna subsystems 80 may accept the service request message and transmits a service accept message. The available one of the plurality of ground station antenna subsystems 80 is defined by a ground station antenna subsystem 80 that is not in communication with another aircraft. The aircraft transceiver may disconnect from communication with one of the plurality of ground station antenna subsystems 80 upon receipt of the service accept message from the available one of the plurality of ground station antenna subsystems.

Signal transmission data rate and modulation format may be modified when the aircraft transceiver disconnects from communication with one of the plurality of ground station antenna subsystems 80 and receives the service accept message from the available one of the plurality of ground station antenna subsystems 80 to maximize receipt of the service accept message. The aircraft beacon transceiver may transmit the service request message once every second, or upon reaching a predetermined altitude, or upon the occurrence of any other predetermined event, as understood by those skilled in the art. The service request message may identify the aircraft and provides the GPS location of the aircraft.

The broadband wireless system of this embodiment of the invention also includes a ground station database in communication with the aircraft transceiver. The ground station database may include ground station locations and open loop points to the nearest ground station. Each of the plurality of ground station antenna subsystems 80 may have a predetermined coverage range. Accordingly, the aircraft preferably sends a service request message to a closest available ground station antenna subsystem 80 and receives a service accept message prior to disconnecting from the ground station antenna subsystems with which it is in communication.

A method aspect of the present invention is for providing broadband wireless access to a moving aircraft. The method may include positioning a plurality of ground station transceivers of a respective plurality of ground stations in communication with a respective plurality of aircraft to transmit and receive signals to and from the respective plurality of aircraft. The method may further include transmitting and receiving signals from the at least one ground station transceiver to one aircraft so that the at least one ground station transceiver is in communication with not more than one aircraft at a time. The method may further include tracking the ground station antenna to the aircraft when the at least one ground station transceiver with which the ground station antenna is associated is in communication with the aircraft.

Another method aspect of the present invention is also for providing broadband wireless access to a moving aircraft. The method may include positioning a plurality of ground station antenna subsystems of a plurality of ground stations in communication with a respective plurality of aircraft to transmit and receive signals to and from the respective plurality of aircraft. The method may also include transmitting and receiving signals from the ground station antenna subsystem to one aircraft so that the ground station antenna subsystem is in communication with not more than one aircraft at a time.

Many modifications and other embodiments of the invention will come to the mind of one skilled in the art having the benefit, of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A broadband wireless system comprising:
a plurality of spaced-apart ground stations for transmitting and receiving signals to and from a respective plurality of aircraft, each of said plurality of ground stations comprising
at least one ground station transceiver including a ground station antenna carried by a mechanically steered platform;
at least one ground station router in communication with the at least one ground station transceiver, and
at least one ground station beacon transceiver in communication with the at least one ground station router;
an aircraft transceiver carried by each of the plurality of aircraft to be positioned in communication with one of the plurality of ground stations, said aircraft transceiver comprising
an aircraft antenna mounted to the aircraft,
an aircraft beacon transceiver carried by the aircraft and in communication with the aircraft antenna, and
an aircraft radio transceiver carried by the aircraft and in communication with the aircraft beacon transceiver; and
a network operations center in communication with each of said plurality of ground stations via a global communications network;
wherein the at least one ground station transceiver transmits signals to and receives signals from not more than one aircraft at a time; and
wherein the ground station antenna tracks the aircraft with which it is in communication.

2. A broadband wireless system according to claim 1 wherein the at least one ground station transceiver includes a ground station radio frequency transceiver and a ground station modem; and wherein the ground station modem transmits at a rate up to about 70 Mb/s.

3. A broadband wireless system according to claim 1 wherein the at least one ground station transceiver operates in a burst mode; and wherein the burst mode is defined by a transmission being sent from the ground station transceiver and received by the aircraft transceiver followed by a transmission being sent from the aircraft transceiver and being received by the ground station transceiver.

4. A broadband wireless system according to claim 1 wherein the at least one ground station transceiver and the aircraft radio transceiver operate in at least one of time-division duplex mode and frequency division duplex mode.

5. A broadband wireless system according to claim 1 wherein each of said plurality of ground stations further comprises a processor in communication with the at least one ground station transceiver, and at least one stepper motor in communication with the processor; and wherein the at least one stepper motor steers the platform to move the ground station antenna responsive to the processor.

6. A broadband wireless system according to claim 5 wherein the processor is in communication with the aircraft transceiver; and wherein the processor steers the platform based on signals received from the aircraft transceiver.

7. A broadband wireless system according to claim 6 wherein the signals received from the aircraft transceiver include GPS signals indicating a location of the aircraft to be positioned in communication with a respective one of the plurality of ground stations transceivers.

8. A broadband wireless system according to claim 1 wherein the aircraft radio transceiver is in communication with an aircraft router carried by the aircraft.

9. A broadband wireless system according to claim 8 wherein the aircraft router provides at least one connection to at least one aircraft service point; and wherein the at least one aircraft service point includes at least one of an in flight entertainment system, an aircraft cockpit, at least one wireless access point and at least one pico/femto cell for connection to a service provider.

10. A broadband wireless system according to claim 8 wherein the aircraft router includes software to buffer the at least one connection to the at least one aircraft service point.

11. A broadband wireless system according to claim 1 further comprising an aircraft terminal processor in communication with the aircraft antenna to track the aircraft antenna towards the respective at least one ground station transceiver with which it is in communication.

12. A broadband wireless system according to claim 1 wherein signals transmitted between the aircraft transceiver and the plurality of ground station transceivers are transmitted using a high frequency so that a transmission beam associated with the signals being transmitted is narrow.

13. A broadband wireless system according to claim 1 wherein the aircraft beacon transceiver operates at or below 1 GHz.

14. A broadband wireless system according to claim 1 wherein the aircraft beacon transceiver operates in a band substantially similar to a communications link between the aircraft and the ground station transceiver.

15. A broadband wireless system according to claim 1 wherein the aircraft beacon transceiver transmits a service request message; and wherein an available one of the plurality of ground station transceivers accepts the service request message and transmits a service accept message; wherein the available one of the plurality of ground station transceivers is defined by a ground station transceiver that is not in communication with another aircraft.

16. A broadband wireless system according to claim 15 wherein the aircraft transceiver disconnects from communication with one of the plurality of ground station transceivers upon receipt of the service accept message from the available one of the plurality of ground stations transceivers.

17. A broadband wireless system according to claim 16 wherein signal transmission data rate and modulation format are modified when the aircraft transceiver disconnects from communication with one of the plurality of ground station transceivers and receives the service accept message from the available one of the plurality of ground station transceivers to maximize receipt of the service accept message.

18. A broadband wireless system according to claim 15 wherein the aircraft beacon transceiver transmits the service request message once every second.

19. A broadband wireless system according to claim 15 wherein the aircraft beacon transceiver transmits the service request message upon reaching a predetermined altitude.

20. A broadband wireless system according to claim 15 wherein the service request message identifies the aircraft and provides the GPS location of the aircraft.

21. A broadband wireless system according to claim 1 further comprising a ground station database in communication with the aircraft transceiver, the ground station database including ground station locations and points to the nearest ground station.

22. A broadband wireless system according to claim 15 wherein each of said plurality of ground stations has a predetermined coverage range; wherein the aircraft sends a service request message to a closest available ground station transceiver and receives a service accept message prior to disconnecting from the ground station transceiver with which it is in communication.

23. A broadband wireless system comprising:
a plurality of spaced-apart ground stations for transmitting and receiving signals to and from a respective plurality of aircraft, each of said plurality of ground stations comprising
a ground station antenna subsystem including a plurality of ground station antennas arranged in a stacked formation;
a ground station router in communication with the plurality of ground station antennas, and
a ground station beacon transceiver in communication with the ground station router;
an aircraft transceiver carried by each of the plurality of aircraft to be positioned in communication with one of the plurality of ground stations, said aircraft transceiver comprising
an aircraft antenna mounted to the aircraft,
an aircraft beacon transceiver carried by the aircraft and in communication with the aircraft antenna, and
an aircraft radio transceiver carried by the aircraft and in communication with the aircraft beacon transceiver; and
wherein the ground station antenna subsystem transmits signals to and receives signals from not more than one aircraft at a time.

24. A broadband wireless system according to claim 23 wherein the stacked formation of the plurality of ground station antennas includes a plurality of rings of ground station antennas.

25. A broadband wireless system according to claim 24 wherein the plurality of rings of ground station antennas includes five rings, wherein a lowermost one of the five rings includes a first predetermined plurality of ground station antennas; wherein upper rings positioned above the lowermost one of the five rings includes less ground station antennas than the lowermost ring; and wherein an uppermost one of the five rings includes one ground station antenna.

26. A broadband wireless system according to claim 23 wherein the ground station antenna subsystem includes a ground station radio frequency transceiver and a ground station modem; and wherein the ground station modem transmits at a rate up to about 70 Mb/s.

27. A broadband wireless system according to claim 23 wherein the ground station antenna subsystem operates in a burst mode; and wherein the burst mode is defined by a transmission being sent from the ground station antenna subsystem and received by the aircraft transceiver followed by a transmission being sent from the aircraft transceiver and being received by the ground station antenna subsystem.

28. A broadband wireless system according to claim 23 wherein the ground station antenna subsystem and the aircraft radio transceiver operate in at least one of time-division duplex mode and frequency division duplex mode.

29. A broadband wireless system according to claim 23 wherein the aircraft transceiver transmits GPS signals indicating a location of the aircraft to be positioned in communication with a respective one of the plurality of ground station antenna subsystems.

30. A broadband wireless system according to claim 23 wherein the aircraft radio transceiver is in communication with an aircraft router carried by the aircraft.

31. A broadband wireless system according to claim 30 wherein the aircraft router provides at least one connection to at least one aircraft service point; and wherein the at least one aircraft service point includes at least one of an in flight entertainment system, an aircraft cockpit, at least one wireless access point and at least one pico/femto cell for connection to a service provider.

32. A broadband wireless system according to claim 31 wherein the aircraft router includes software to buffer the at least one connection to the at least one aircraft service point.

33. A broadband wireless system according to claim 23 further comprising an aircraft terminal processor carried by the aircraft and in communication with the aircraft antenna to track the aircraft antenna towards the respective at least one ground station antenna subsystem with which it is in communication.

34. A broadband wireless system according to claim 23 wherein signals transmitted between the aircraft transceiver and the respective ground station antenna subsystem with which it is in communication are transmitted using a high frequency so that a transmission beam associated with the signals being transmitted is narrow.

35. A broadband wireless system according to claim 23 wherein the aircraft beacon transceiver operates at or below 1 GHz.

36. A broadband wireless system according to claim 23 wherein the aircraft beacon transceiver operates in a band substantially similar to a communications link between the aircraft and the ground station antenna subsystem.

37. A broadband wireless system according to claim 23 wherein the aircraft beacon transceiver transmits a service request message; and wherein an available one of the plurality of ground station antenna subsystems accepts the service request message and transmits a service accept message; wherein the available one of the plurality of ground station antenna subsystems is defined by a ground station antenna subsystem that is not in communication with another aircraft.

38. A broadband wireless system according to claim 37 wherein the aircraft transceiver disconnects from communication with one of the plurality of ground station antenna subsystems upon receipt of the service accept message from the available one of the plurality of ground station antenna subsystems.

39. A broadband wireless system according to claim 38 wherein signal transmission data rate and modulation format are modified when the aircraft transceiver disconnects from communication with one of the plurality of ground station antenna subsystems and receives the service accept message from the available one of the plurality of ground station antenna subsystems to maximize receipt of the service accept message.

40. A broadband wireless system according to claim 37 wherein the aircraft beacon transceiver transmits the service request message at least one of once every second and upon reaching a predetermined altitude; and wherein the service request message identifies the aircraft and provides the GPS location of the aircraft.

41. A broadband wireless system according to claim 23 further comprising a ground station database in communication with the aircraft transceiver, the ground station database including ground station locations and open loop points to the nearest ground station.

42. A broadband wireless system according to claim 37 wherein each of said plurality of ground station antenna subsystems has a predetermined coverage range; wherein the aircraft sends a service request message to a closest available ground station antenna subsystem and receives a service accept message prior to disconnecting from the ground station antenna subsystem with which it is in communication.

43. A method for providing broadband wireless access to a moving aircraft, the method comprising:
positioning a plurality of ground station transceivers of a respective plurality of ground stations in communication with a respective plurality of aircraft to transmit and receive signals to and from the respective plurality of aircraft, each of the plurality of ground stations comprising at least one ground station transceiver including a ground station antenna, at least one ground station router in communication with the at least one ground station transceiver, and at least one ground station beacon transceiver in communication with the at least one ground station router;
transmitting and receiving signals from the at least one ground station transceiver to one aircraft so that the at least one ground station transceiver is in communication with not more than one aircraft at a time; and
tracking the ground station antenna to the aircraft when the at least one ground station transceiver with which the ground station antenna is associated is in communication with the aircraft.

44. A method according to claim 43 further comprising positioning each of the plurality of ground stations in communication with a network operations center.

45. A method according to claim 43 wherein each of the plurality of aircraft include an aircraft transceiver to be positioned in communication with one of the plurality of ground station transceivers, each aircraft transceiver including an aircraft antenna mounted to the aircraft, an aircraft beacon transceiver carried by the aircraft and in communication with the aircraft antenna, and an aircraft radio transceiver carried by the aircraft and in communication with the aircraft beacon transceiver.

46. A method according to claim 43 wherein the at least one ground station transceiver includes a ground station radio frequency transceiver and a ground station modem; and further comprising transmitting signals from the ground station modem at a rate up to about 70 Mb/s.

47. A method according to claim 45 further comprising operating the at least one ground station transceiver in a burst mode; and wherein the burst mode is defined by transmitting a signal from the at least one ground station transceiver to the aircraft transceiver followed by transmitting a signal from the aircraft transceiver to the ground station transceiver; and further comprising operating the at least one ground station transceiver and the aircraft radio transceiver in at least one of time-division duplex mode and frequency division duplex mode.

48. A method according to claim 45 wherein tracking the ground station antenna comprises mechanically steering the ground station antenna; and further comprising steering the platform to move the ground station antenna responsive to a processor in communication with the at least one ground station transceiver; wherein the processor is in communication with the aircraft transceiver and steers the platform based on signals received from the aircraft transceiver.

49. A method according to claim 45 further comprising transmitting GPS signals from the aircraft transceiver to the ground station transceiver to indicate a location of the aircraft to be positioned in communication with a respective one of the plurality of ground stations.

50. A method according to claim 45 wherein the aircraft radio transceiver is in communication with an aircraft router carried by the aircraft; wherein the aircraft router provides at least one connection to at least one aircraft service point; and wherein the at least one aircraft service point includes at least one of an in flight entertainment system, an aircraft cockpit, at least one wireless access point and at least one pico/femto cell for connection to a service provider; and further comprising buffering the at least one connection to the at least one aircraft service point.

51. A method according to claim 45 further comprising tracking the aircraft antenna towards the respective at least one ground station transceiver with which it is in communication.

52. A method according to claim 45 further comprising using a high frequency to transmit signals between the aircraft transceiver and the at least one ground station transceiver so that a transmission beam associated with the signals being transmitted is narrow.

53. A method according to claim 45 wherein the aircraft beacon transceiver operates at or below 1 GHz.

54. A method according to claim 45 wherein the aircraft beacon transceiver operates in a band substantially similar to a communications link between the aircraft and the at least one ground station transceiver.

55. A method according to claim 45 further comprising transmitting a service request message from the aircraft beacon transceiver to an available one of the plurality of ground station transceivers and wherein the available one of the plurality of ground station transceivers accepts the service request message; and transmitting a service accept message from the available one of the ground station transceivers; wherein the available one of the plurality of ground station transceivers is defined by a ground station transceiver that is not in communication with another aircraft.

56. A method according to claim 55 further comprising disconnecting the aircraft transceiver from communication with one of the plurality of ground station transceivers upon receipt of the service accept message from the available one of the plurality of ground station transceivers.

57. A method according to claim 56 further comprising modifying signal transmission data rate and modulation format when the aircraft transceiver disconnects from communication with one of the plurality of ground station transceivers and receives the service accept message from the available one of the plurality of ground station transceivers to maximize receipt of the service accept message.

58. A method according to claim 55 wherein transmitting the service request message comprises at least one of transmitting the service request message once every second and transmitting the service request message upon the aircraft reaching a predetermined altitude; and wherein the service request message identifies the aircraft and provides the GPS location of the aircraft.

59. A method according to claim 55 wherein each of the plurality of ground station transceivers has a predetermined coverage range; wherein the aircraft sends a service request message to a closest available one of the plurality of ground station transceivers and receives a service accept message prior to disconnecting from the ground station transceiver with which it is in communication.

60. A method for providing broadband wireless access to a moving aircraft, the method comprising:
positioning a plurality of ground station antenna subsystems of a respective plurality of ground stations in communication with a respective plurality of aircraft to transmit and receive signals to and from the respective plurality of aircraft, each of the ground station antenna subsystem including a plurality of ground station antennas arranged in a stacked formation, a ground station router in communication with the plurality of ground station antennas, and a ground station beacon transceiver in communication with the ground station router; and
transmitting and receiving signals from the ground station antenna subsystem to one aircraft so that the ground station antenna subsystem is in communication with not more than one aircraft at a time.

61. A method according to claim 60 wherein the stacked formation of the plurality of ground station antennas includes a plurality of rings of ground station antennas.

62. A method according to claim 61 wherein the plurality of rings of ground station antennas includes five rings, wherein a lowermost one of the five rings includes a first predetermined plurality of ground station antennas, and upper rings positioned above the lowermost one of the five rings includes less ground station antennas than the lowermost ring, and wherein an uppermost one of the five rings includes one ground station antenna.

63. A method according to claim 60 wherein each of the plurality of aircraft include an aircraft transceiver to be positioned in communication with one of the plurality of ground stations, each aircraft transceiver including an aircraft antenna mounted to the aircraft, an aircraft beacon transceiver carried by the aircraft and in communication with the aircraft antenna, and an aircraft radio transceiver carried by the aircraft and in communication with the aircraft beacon transceiver.

64. A method according to claim 63 wherein the ground station antenna subsystem includes a ground station radio frequency transceiver and a ground station modem; and further comprising transmitting signals from the ground station modem at a rate up to about 70 Mb/s.

65. A method according to claim 63 further comprising operating the ground station antenna subsystem in a burst mode; and wherein the burst mode is defined by transmitting a signal from the ground station antenna subsystem to the aircraft transceiver followed by transmitting a signal from the aircraft transceiver to the ground station antenna subsystem.

66. A method according to claim 63 further comprising operating the ground station antenna subsystem and the aircraft radio transceiver operate in at least one of time-division duplex mode and frequency division duplex mode.

67. A method according to claim 63 further comprising transmitting GPS signals from the aircraft transceiver to the ground station antenna subsystem to indicate a location of the aircraft to be positioned in communication with a respective one of the plurality of ground station antenna subsystems.

68. A method according to claim 63 wherein the aircraft radio transceiver is in communication with an aircraft router carried by the aircraft; wherein the aircraft router provides at least one connection to at least one aircraft service point; and wherein the at least one aircraft service point includes at least one of an in flight entertainment system, an aircraft cockpit, at least one wireless access point and at least one pico/femto cell for connection to a service provider; and further comprising buffering the at least one connection to the aircraft service point.

69. A method according to claim 63 further comprising tracking the aircraft antenna towards the respective at least one ground station antenna subsystem with which it is in communication.

70. A method according to claim 63 further comprising using a high frequency to transmit signals between the aircraft transceiver and the plurality of ground station antenna subsystem with which it is in communication so that a transmission beam associated with the signals being transmitted is narrow.

71. A method according to claim 63 wherein the aircraft beacon transceiver operates at or below 1 GHz.

72. A method according to claim 63 wherein the aircraft beacon transceiver operates in a band substantially similar to a communications link between the aircraft and the ground station antenna subsystem.

73. A method according to claim 63 further comprising transmitting a service request message from the aircraft beacon transceiver to an available one of the plurality of ground station antenna subsystems and wherein the available one of the plurality of ground station antenna subsystems accepts the service request message; and transmitting a service accept message from the available one of the ground station antenna subsystems; wherein the available one of the plurality of ground station antenna subsystems is defined by a ground station antenna subsystem that is not in communication with another aircraft.

74. A method according to claim 73 further comprising disconnecting the aircraft transceiver from communication with one of the plurality of ground station antenna subsystems upon receipt of the service accept message from the available one of the plurality of ground station antenna subsystems.

75. A method according to claim 74 further comprising modifying signal transmission data rate and modulation format when the aircraft transceiver disconnects from communication with one of the plurality of ground station antenna subsystems and receives the service accept message from the available one of the plurality of ground station antenna subsystems to maximize receipt of the service accept message.

76. A method according to claim 73 wherein transmitting the service request message comprises at least one of transmitting the service request message once every second and transmitting the service request message upon reaching a predetermined altitude; and wherein the service request message identifies the aircraft and provides the GPS location of the aircraft.

77. A method according to claim 73 wherein each of the plurality of ground station antenna subsystems has a predetermined coverage range; wherein the aircraft sends a service request message to a closest available ground station antenna subsystem and receives a service accept message prior to disconnecting from the ground station antenna subsystem with which it is in communication.
